(19) United States
(12) Patent Application Publication
(10) Pub. No.: US 2021/0233719 A1
(43) Pub. Date: Jul. 29, 2021

(54) ELECTROCHEMICAL CAPACITOR

(71) Applicants: Murata Manufacturing Co., Ltd., Nagaokakyo-shi (JP); Drexel University, Philadelphia, PA (US)

(72) Inventors: Takeshi Torita, Nagaokakyo-shi (JP); Yuichi Honda, Nagaokakyo-shi (JP); Yury Gogotsi, Ivyland, PA (US); Xuehang Wang, Philadelphia, PA (US)

(21) Appl. No.: 17/212,400

(22) Filed: Mar. 25, 2021

Related U.S. Application Data
(63) Continuation of application No. PCT/JP2019/039673, filed on Oct. 8, 2019.
(60) Provisional application No. 62/743,630, filed on Oct. 10, 2018.

(51) Int. Cl. H01G 11/32; H01G 11/02; H01G 11/58; H01G 11/06

(52) U.S. Cl. CPC H01G 11/32; H01G 11/06; H01G 11/58; H01G 11/02

(57) ABSTRACT

An electrochemical capacitor having an electrolytic solution that is a mixed solution of lithium bis(trifluoromethanesulfonyl)imide (Li-TFSI) and propylene carbonate (PC), a mixed solution of lithium borofluoride and PC, a mixed solution of Li-TFSI, ethylene carbonate, and diethyl carbonate, a mixed solution of Li-TFSI and ethyl isopropyl sulfone, or a mixed solution of Na-TFSI and PC; a cathode in the electrolytic solution, the cathode being a layered material having multiple layers, each layer having a crystal lattice represented by Mₙ₊₁Xₙ, where M is a metal of Group 3 to 7, X is a carbon/nitrogen atom, n is 1, 2 or 3, X is positioned within an octahedral array of M, and having a modifier T of a hydroxyl group or a fluorine/oxygen/hydrogen atom on the surface of each layer; and an anode in the electrolytic solution and separated from the cathode, the anode being a carbon-based material.

### CROSS REFERENCE TO RELATED APPLICATIONS

The present application is a continuation of International application No. PCT/JP2019/039673, filed Oct. 8, 2019, which claims priority to Provisional Patent Application No. 62/743,630, filed Oct. 10, 2018, the entire contents of each of which are incorporated herein by reference.

### FIELD OF THE INVENTION

The present invention relates to an electrochemical capacitor and more particularly to an electrochemical capacitor in which a cathode and an anode are disposed in an electrolytic solution and separated from each other.

### BACKGROUND OF THE INVENTION

An electrochemical capacitor is a capacitor utilizing the capacity developed by a physicochemical reaction between an electrode (electrode active material) and an ion (electrolyte ion) in an electrolytic solution, and can be used as a device (electricity storage device) for storing electrical energy. Among the electrochemical capacitors, those in which metal oxides, layered materials (or intercalation compounds) and the like are utilized for an electrode active material and the capacity (pseudocapacity) is developed by the occurrence of a reaction (for example, a change in the oxidation number of a metal element constituting the electrode active material) involving the donating and receiving of electrons between an electrode and an ion in an electrolytic solution are called “pseudo capacitors”, “redox capacitors” and the like.

As such an electrochemical capacitor (particularly, a pseudo capacitor), an electrochemical capacitor using or containing MXene as an electrode active material is known (see Patent Literature 1 and Non-Patent Literature 1). MXene is a kind of so-called two-dimensional material and, as to be described later, is a layered material in the form of a plurality of layers, in which each layer has a crystal lattice which is represented by Mₙ₊₁Xₙ, wherein M is at least one metal of Group 3, 4, 5, 6, or 7, X is a carbon atom and/or a nitrogen atom, and n is 1, 2, or 3, and in which each X is positioned within an octahedral array of M and has a terminal (or modifier) T, for example, a hydroxyl group, a fluorine atom, an oxygen atom, or a hydrogen atom on the surface of each layer.

Meanwhile, an electrochemical capacitor utilizing graphene as an electrode active material is also known. Graphene is a two-dimensional material composed of a honeycomb-like hexagonal lattice structure formed by sp2 hybridization between carbon atoms. It is known that an electrochemical capacitor utilizing graphene of which the structure has been subjected to various treatments as an anode and a cathode exhibits an excellent energy density (see Non-Patent Literatures 1 to 3).
Patent Literature 1: WO 2018/066549 A
Non-Patent Literature 1: Jun Yan et al, “Flexible MXene/Graphene Films for Ultrafast Supercapacitors with Outstanding Volumetric Capacitance,” Advanced Functional Materials, 2017, vol. 27, 1701264
Non-Patent Literature 2: Xiaowei Yang et al, “Liquid-Mediated Dense Integration of Graphene Materials for Compact Capacitive Energy Storage,” Science, 2013, vol. 341, pp. 534-537
Non-Patent Literature 3: Yuxi Xu et al, “Holey graphene frameworks for highly efficient capacitive energy storage,” NATURE COMMUNICATIONS, 2014, vol. 5, Article number 4554

### SUMMARY OF THE INVENTION

As an electrolytic solution which can be used in an electrochemical capacitor, generally a water-based electrolytic solution (an electrolytic solution in which an electrolyte is dissolved in a water solvent) and a non-aqueous electrolytic solution (an electrolytic solution in which an electrolyte is dissolved in a non-aqueous solvent or an electrolytic solution composed of an ionic liquid) are known. In the case of a water-based electrolytic solution, the operating potential range (hereinafter also referred to as a potential window) of the electrochemical capacitor is limited to a maximum of 1.2 V or less so as not to cause electrolysis of water, and there is thus a disadvantage of limiting the energy density (calculated by ½×CV², wherein C is the specific capacity (in more detail, the capacity per unit mass of electrode active material (F/g) or capacity per unit volume of electrode active material (F/cm³), hereinafter, these are also generically referred to as “specific capacity” in the present specification) and V means the potential window (V)). In addition, in the case of a water-based electrolytic solution, the usable temperature range of the electrochemical capacitor is limited to the temperature at which water can stably exist as a liquid (temperature which does not cause freezing and vaporization) and there is a disadvantage of making it difficult to use the water-based electrolytic solution at a low temperature. On the other hand, a non-aqueous electrolytic solution can avoid such a disadvantage.

Non-Patent Literature 1 discloses an electrochemical capacitor in which a mixture of Ti₃C₂Tₓ (Tₓ is a surface functional group), which is one of MXene with 5 wt % of graphene, is used in an anode and a cathode. In the electrochemical capacitor, graphene in the anode and the cathode is used in order to control the inter-layer distance of MXene. However, a sulfuric acid solution which is a water-based electrolytic solution is used as the electrolytic solution in the electrochemical capacitor, and thus the electrochemical capacitor has the problems of potential window and usable temperature range particularly at a low temperature as described above.

Patent Literature 1 discloses an electrochemical capacitor in which MXene as an electrode active material is used in either of the anode or the cathode and a non-aqueous electrolytic solution containing a non-aqueous solvent and an electrolyte which generates protons in the non-aqueous solvent is used (see, for example, paragraphs [0029] to [0035] of Patent Literature 1). More specifically, Patent Literature 1 discloses that the capacitor characteristics of the electrochemical capacitor are evaluated using Ti₃C₂Tₛ (Tₛ is a surface functional group), which is one of MXene in the cathode, an activated carbon membrane having an excess capacity as the anode, an Ag wire as a reference electrode, and a mixture of 1-ethyl-3-methylimidazolium bis(trifluoromethylsulfonyl)imide (EMI-TFSI) with bis(trifluoromethylsulfonyl)imide (HTFSI) as a non-aqueous electrolytic solution in a tripolar Swagelok cell. In such an electrochemical capacitor, a wide potential window (see paragraphs [0062] to [0063] in Patent Literature 1, potential window: 3.0 V) is realized. However, in the electrochemical capacitor of Patent Literature 1, the electrolytic solution exhibits strong acidity since the electrolytic solution contains an electrolyte (for example, HTFSI) which generates protons in a non-aqueous solvent, and a material which is not acid-corroded by such an electrolytic solution is required to be selected as a member (a so-called package, specifically, a container (cell) and a separator, if present) which can be in contact with the electrolytic solution in the electrochemical capacitor.

Non-Patent Literature 2 discloses an electrochemical capacitor in which micropored graphene is compressed to increase the density and used in the anode and the cathode. Non-Patent Literature 3 discloses an electrochemical capacitor in which graphene is subjected to a surface treatment to be gelled, then compressed to increase the density, and used in the anode and the cathode. In the electrochemical capacitors of Non-Patent Literatures 2 and 3, graphene is used in the anode and the cathode, it is described that both the electrochemical capacitors can achieve a high energy density, but acetonitrile is used as a solvent for the electrolytic solution. Here, the usable temperature range of the electrochemical capacitor required to be secured in the fields of consumer apparatuses and industrial apparatuses (such as motor vehicles) is about −40 degrees to 80 degrees. These electrochemical capacitors have disadvantages in the use at a high temperature since the boiling point of acetonitrile is 82 degrees.

Generally, in the case of using a certain material as the electrode active material of the cathode of an electrochemical capacitor, the energy density to be attained largely changes depending on not only the material of the electrode active material of the anode but also the composition of the electrolytic solution (combination of an electrolyte and a solvent). Hence, in the case of using MXene as an electrode active material of the cathode, it is extremely difficult to predict the combination of an electrolyte and a solvent in a suitable electrolytic solution so that a sufficiently high energy and a sufficiently high power density can be achieved. In addition, it is more difficult to select the combination of an electrolyte and a solvent in an electrolytic solution so that the conditions of a usable temperature range from a low temperature to a high temperature can be practically satisfied as an electrochemical capacitor and acid corrosion of the member of the capacitor by the electrolytic solution cannot occur.

An object of the present invention is to provide a novel electrochemical capacitor in which a cathode and an anode are disposed in an electrolytic solution and separated from each other, where MXene is used as an electrode active material of the cathode, and the electrolytic solution does not generate a proton in the solvent and which has a suitable usable temperature range and can achieve a sufficiently high energy density and a sufficiently high power density.

According to an aspect of the present invention, there is provided an electrochemical capacitor comprising:

an electrolytic solution that is any one selected from the group consisting of a mixed solution comprising lithium bis(trifluoromethanesulfonyl)imide and propylene carbonate, a mixed solution comprising lithium borofluoride and propylene carbonate, a mixed solution comprising lithium bis(trifluoromethanesulfonyl)imide, ethylene carbonate, and diethyl carbonate, a mixed solution comprising lithium bis(trifluoromethanesulfonyl)imide and ethyl isopropyl sulfone, and a mixed solution comprising sodium bis(trifluoromethanesulfonyl)imide and propylene carbonate;

a cathode in the electrolytic solution, the cathode comprising, as an electrode active material, a layered material comprising a plurality of layers, each layer having a crystal lattice represented by:

Mₙ₊₁Xₙ

wherein M is at least one metal of Group 3, 4, 5, 6, or 7,

X is a carbon atom, a nitrogen atom, or a combination thereof,

n is 1, 2, or 3,

each X is positioned within an octahedral array of M, and

having at least one modifier or terminal T selected from the group consisting of a hydroxyl group, a fluorine atom, an oxygen atom, and a hydrogen atom on at least one of two opposing surfaces of said each layer; and

an anode in the electrolytic solution and separated from the cathode, the anode comprising a carbon-based material as an electrode active material.

According to the electrochemical capacitor of the present invention, it is possible to achieve a sufficiently high energy density and a sufficiently high power density in a suitable usable temperature range without allowing the electrolytic solution to generate a proton in the solvent as the prescribed layered material (also referred to as “MXene” in the present disclosure) is used as an electrode active material of the cathode, a carbon-based material is used as an electrode active material of the anode, and the specific mixed solution (the specific combination of an electrolyte and a solvent) is used as an electrolytic solution.

In a mode of the present invention, the formula Mₙ₊₁Xₙ can be any one selected from the group consisting of Ti₃C₂, Ti₂C, and V₂C.

According to the present invention, MXene is used as an electrode active material of the cathode and the electrolytic solution does not contain an electrolyte which generates protons in an electrochemical capacitor in which a cathode and an anode are disposed in an electrolytic solution and separated from each other, and thus a novel electrochemical capacitor is provided which has an excellent degree of freedom in selection of the materials of members constituting the electrochemical capacitor. Furthermore, the specific mixed solution (the specific combination of an electrolyte and a solvent) is used as an electrolytic solution in the novel electrochemical capacitor, and thus the novel electrochemical capacitor has a suitable usable temperature range from a low temperature to a high temperature and can achieve a sufficiently high energy density and a sufficiently high power density.

### BRIEF DESCRIPTION OF THE DRAWINGS

FIG. 1 is a schematic cross-sectional view for explaining an electrochemical capacitor in an embodiment of the present invention.

FIG. 2 is a schematic cross-sectional view illustrating MXene which is a layered material usable in an electrochemical capacitor in an embodiment of the present invention.

### DETAILED DESCRIPTION OF THE PREFERRED EMBODIMENTS

Hereinafter, embodiments of the electrochemical capacitor of the present invention will be described in detail but the present invention is not limited to these embodiments.

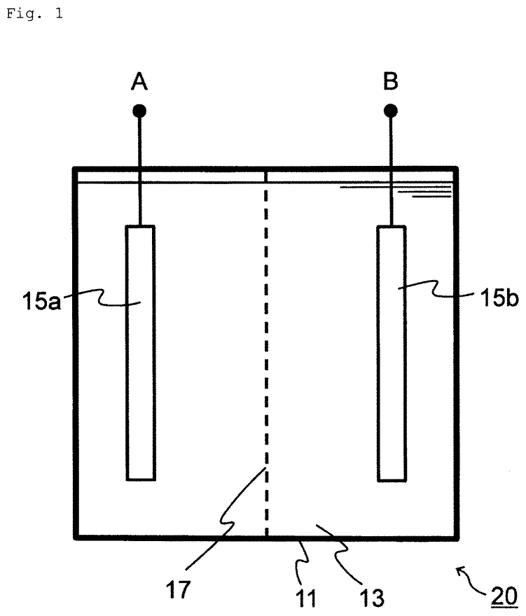

Referring to FIG. 1, an electrochemical capacitor 20 of the present embodiment has a configuration in which a cathode 15a and an anode 15b are disposed in an electrolytic solution 13 to be separated from each other. The cathode 15a and the anode 15b are electrically connected to terminals A and B, respectively and thus can function as electrodes. In the illustrated aspect, the cathode 15a and the anode 15b can be disposed in the electrolytic solution 13, for example, (although not essential in the present embodiment) with a separator 17 interposed therebetween to be separated from each other in any appropriate container (or cell) 11. Any appropriate member can be used as the separator 17 as long as the movement of the electrolyte ions in the electrolytic solution 13 is not impeded. For example, porous membranes of polyolefins such as polypropylene and polytetrafluoroethylene can be used. The material of the container 11 is not particularly limited, and may be, for example, a metal such as stainless steel, a resin such as polytetrafluoroethylene, and any other appropriate materials. The container 11 may be sealed or open, and an empty space may exist or may not exist in the container 11. It is noted that the cathode 15a and the anode 15b may be disposed in the container 11 to be separated from each other in any appropriate form other than the illustrated form, for example, the cathode 15a and the anode 15b are stacked and wound with the separator 17 interposed therebetween.

The cathode 15a contains a prescribed layered material including a plurality of layers as an electrode active material. The electrode active material refers to a substance which donates and receives an electron to and from the electrolyte ion in the electrolytic solution 13.

The prescribed layered material which can be used in the present embodiment is MXene and is defined as follows:
a layered material including a plurality of layers, each layer having a crystal lattice which is represented by the following formula:

Mₙ₊₁Xₙ

wherein M is at least one metal of Group 3, 4, 5, 6, or 7 and can include a so-called early transition metal, for example, at least one selected from the group consisting of Sc, Ti, Zr, Hf, V, Nb, Ta, Cr, Mo, and Mn,

X is a carbon atom, a nitrogen atom, or a combination thereof, and

n is 1, 2, or 3, and
in which each X is positioned within an octahedral array of M, and having at least one modifier or terminal T selected from the group consisting of a hydroxyl group, a fluorine atom, an oxygen atom, and a hydrogen atom on at least one of two opposing surfaces of said each layer (this is also represented by “Mₙ₊₁XₙTₛ”, wherein s is any number and x is conventionally used instead of s in some cases).

Such MXene is obtainable by selectively etching A atoms from a MAX phase. The MAX phase has a crystal lattice which is represented by the following formula:

Mₙ₊₁AXₙ

(wherein M, X, and n are as described above and A is at least one element of Group 12, 13, 14, 15, or 16, normally an element of A Group, typically of IIIA Group and IVA Group, more specifically can include at least one selected from the group consisting of Al, Ga, In, Tl, Si, Ge, Sn, Pb, P, As, S, and Cd, and is preferably Al) and in which each X is positioned within an octahedral array of M, and has a crystal structure in which a layer composed of A atoms is positioned between layers represented by Mₙ₊₁Xₙ. The MAX phase schematically includes a repeating unit in which each one of layers of X atoms is disposed between adjacent layers of n+1 layers of M atoms (these are also collectively referred to as a “Mₙ₊₁Xₙ layer”), and a layer of A atoms (“A atom layer”) is disposed as a layer next to the (n+1)th layer of M atoms. As A atoms are selectively etched from the MAX phase, the A atom layer is removed and the exposed surface of the Mₙ₊₁Xₙ layer is modified by hydroxyl groups, fluorine atoms, oxygen atoms, hydrogen atoms or the like present in an etching liquid (usually, an aqueous solution of a fluorine-containing acid is used, but it is not limited thereto) so that the surface is terminated.

Typically, in the above formulae, M can be titanium or vanadium and X can be a carbon atom or a nitrogen atom. For example, the MAX phase is Ti₃AlC₂ and MXene is Ti₃C₂Tₛ.

It is noted, in the present invention, MXene may contain remaining A atoms at a relatively small amount, for example, at 10 mass % or less with respect to the original amount of A atoms.

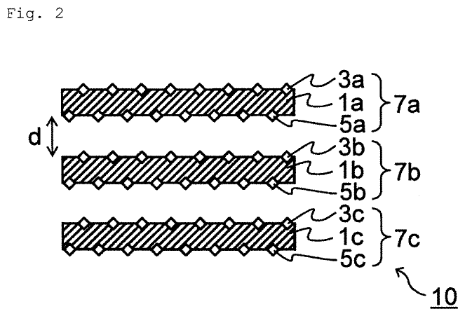

As schematically illustrated in FIG. 2, MXene 10 to be thus obtained can be a layered material having two or more MXene layers 7a, 7b, and 7c (this is also represented by “Mₙ₊₁XₙTₛ”, wherein s is an arbitrary number) in which Mₙ₊₁Xₙ layers 1a, 1b, and 1c are surface-modified or terminated with modifiers or terminals T 3a, 5a, 3b, 5b, 3c, and 5c (in the drawing, three layers are illustrated as an example, but it is not limited thereto). The MXene 10 may be one (single layer structure) in which a plurality of such MXene layers exist to be separated from one another, a laminate (multilayer structure) in which a plurality of MXene layers are stacked to be separated from each other, or a mixture of these. MXene can be an aggregation (also can be referred to as particles, powder, or flakes) of individual MXene layers (single layers) and/or laminates of MXene layers. In a case in which MXene is a laminate, two adjacent MXene layers (for example, 7a and 7b, 7b and 7c) may not necessarily be completely separated from each other but may be partially in contact with each other.

Although the present embodiment is not limited, the thickness of each layer of MXene (corresponding to the MXene layers 7a, 7b, and 7c) is, for example, 0.8 nm to 5 nm, and particularly 0.8 nm to 3 nm (can vary mainly depending on the number of M atom layers included in each layer), the maximum dimension in a plane (two-dimensional sheet plane) parallel to the layer is, for example, 0.1 μm to 200 μm and particularly 1 μm to 40 μm. In a case in which MXene is a laminate, the inter-layer distance (or the gap dimension, denoted as d in FIG. 1) in the individual laminate is, for example, 0.8 nm to 10 nm, particularly 0.8 nm to 5 nm, and more particularly about 1 nm. The total number of layers may be 2 or more but is, for example, not less than 50 and not more than 100,000 and particularly not less than 1,000 and not more than 20,000. The thickness in the stacking direction is, for example, 0.1 μm to 200 μm and particularly 1 μm to 40 μm. The maximum dimension in a plane (two-dimensional sheet plane) perpendicular to the stacking direction is, for example, 0.1 μm to 100 μm and particularly 1 μm to 20 μm. It is noted that these dimensions are determined as number average dimensions (for example, number average of at least 40) based on a scanning electron microscope (SEM) or transmission electron microscope (TEM) photograph.

The cathode 15a may be substantially composed only of MXene which is an electrode active material or may be composed by adding a binder and the like to this. The binder can be typically a resin, and, for example, at least one selected from the group consisting of polytetrafluoroethylene, polyvinylidene fluoride, styrene butadiene rubber, and the like can be used.

The anode 15b may be one containing as an electrode active material, any appropriate carbon-based material which can function as a counter electrode of the cathode 15a. As a carbon-based material having a high density of particularly 0.2 g/cm³ or more, more particularly 0.5 g/cm³ or more, and even more particularly 1.0 g/cm³ or more is used, a higher energy density per volume can be achieved. For example, the carbon-based material includes graphene, graphite, carbon nanotubes, activated carbon, and fullerene although it is not limited thereto. In particular, a higher energy density per volume can be achieved as graphene having the highest density among these is used.

As the graphene, for example, CVD graphene produced by a vapor phase method or graphene obtained by oxidizing graphite to produce graphene oxide and then further reducing this graphene oxide (hereinafter, the graphene thus obtained is also referred to as reduced graphene oxide) can be used. The density of the reduced graphene oxide is, for example, about 1 g/cm³ to 2 g/cm³. Carbon nanotubes may form the anode 15b as a simple substance. Alternatively, carbon nanotubes are used, for example, by being mixed in a small amount with graphene. A small amount of carbon nanotubes suitably acts to open the gap into which ions enter, against the force by which the graphene attracts each other. Activated carbon may form the anode 15b as a simple substance. Alternatively, activated carbon may be used by being mixed with carbon black which is carbon fine particles. This is because the electrical conductivity is enhanced by mixing activated carbon with carbon black.

The anode 15b may be substantially composed only of a carbon-based material which is an electrode active material or may be composed by adding a binder and the like to this. The binder can be typically a resin, and, for example, at least one selected from the group consisting of polytetrafluoroethylene, polyvinylidene fluoride, styrene butadiene rubber, and the like can be used.

The cathode 15a and the anode 15b may be independently in the form of a free standing film or may be formed in the form of a film and/or a membrane on a current collector (not illustrated). The current collector can be composed of, for example, stainless steel, aluminum, and an aluminum alloy although any appropriate electrically conductive material may be used.

The electrolytic solution 13 is any one selected from the group consisting of

a mixed solution containing lithium bis(trifluoromethanesulfonyl)imide (Li-TFSI) as an electrolyte and propylene carbonate (PC) as a solvent,

a mixed solution containing lithium borofluoride (Li—BF₄) as electrolyte and propylene carbonate (PC) as solvent,

a mixed solution containing lithium bis(trifluoromethanesulfonyl)imide (Li-TFSI) as an electrolyte, and ethylene carbonate (EC) and diethyl carbonate (DEC) as solvents,

a mixed solution containing lithium bis(trifluoromethanesulfonyl)imide (Li-TFSI) as an electrolyte and ethyl isopropyl sulfone (EiPS) as a solvent, and

a mixed solution containing sodium bis(trifluoromethanesulfonyl)imide (Na-TFSI) as an electrolyte and propylene carbonate (PC) as a solvent.

The present inventors have found out that the potential window on the cathode side is widened and the specific capacity also increases as the specific mixed solution (the specific combination of an electrolyte and a solvent) is used as an electrolytic solution in the case of using MXene as an electrode active material of the cathode of an electrochemical capacitor. Furthermore, according to this electrolytic solution, the electrochemical capacitor can have a suitable usable temperature range from a low temperature to a high temperature and does not generate protons in the solvent. Furthermore, in the electrochemical capacitor, it is possible to widen the potential window on the anode side and to increase the specific capacity as a carbon-based material is used as an electrode active material of the anode. It is thus possible to obtain an electrochemical capacitor capable of achieving a sufficiently high energy density and a sufficiently high power density. Here, a sufficiently high energy density is an energy density to be about three-fold the energy density to be achieved in the case of using activated carbon, which is a conventional material, in both the cathode and the anode.

The molar concentration of the electrolyte (Li-TFSI, Li—BF₄, Na-TFSI) in the electrolytic solution 13 is not particularly limited. Those skilled in the art can appropriately adjust the molar concentration, the sum of the respective molar concentrations, and the blending ratio to suitable values. For example, the suitable molar concentration and sum of the respective molar concentrations may be not less than 0.01 mol/L and not more than 10 mol/L, particularly not less than 0.2 mol/L and not more than 6 mol/L, and more particularly not less than 0.5 mol/L and not more than 4 mol/L (all based on the entire mixture).

In a case in which the electrolytic solution 13 contains two solvents, namely, EC and DEC, the blending ratio such as the volume ratio is not particularly limited. Those skilled in the art can appropriately adjust the blending ratio to a suitable value. For example, the volume ratio can be adjusted to EC:DEC=3:7.

The electrolytic solution 13 may contain any appropriate additives in relatively small amounts in addition to the solvent and the electrolyte.

Terminals A and B of the electrochemical capacitor 20 can be connected to a load to perform charge. At this time, the cations in the electrolytic solution 13 and/or the cations bonded to the carbon-based material which is an electrode active material of the anode 15b are attracted to the cathode 15a and induced to MXene which is an electrode active material of the cathode 15a.

Further, the terminals A and B of the electrochemical capacitor 20 can be connected to a power source to perform discharge. At this time, the cations which have been induced to the cathode 15a at the time of charge move away from the cathode 15a at the time of discharge. It is presumed that the cation can be inserted into the gap and the like of the carbon-based material since the electrode active material of the anode 15b contains a carbon-based material.

In the electrochemical capacitor of the present embodiment, PC, EC, DEC, and EiPS are understood as non-aqueous solvents. The electrolytic solution 13 is any one among the specific combinations of Li-TFSI with PC, Li—BF₄ with PC, Li-TFSI with EC and DEC, Li-TFSI with EiPS, and Na-TFSI with PC. In other words, the electrolytic solution 13 may be a non-aqueous electrolytic solution which does not contain water. Hence, the electrochemical capacitor of the present embodiment attains a large potential window and a wider usable temperature range from a low temperature to a high temperature as compared with a case of using a water-based electrolytic solution and a case of using a non-aqueous solvent containing acetonitrile as a solvent. The potential window of the electrochemical capacitor of the present embodiment is, for example, 1.5 V or more, particularly 1.85 V or more, more particularly 2.0 V or more, preferably 2.4 V or more, more preferably 2.5 V or more, even more preferably 2.8 V or more, and even particularly preferably 3 V or more. The upper limit thereof is not particularly limited but may be typically 4 V or less. A suitable usable temperature range of the electrochemical capacitor of the present embodiment can be −40° C. to 90° C., particularly −40° C. to 85° C., more particularly −40° C. to 83° C., and even more particularly −40° C. to 80° C.

According to the electrochemical capacitor of the present embodiment, a sufficiently high energy density can be achieved by use of the specific mixed solution (specific combination of an electrolyte and a solvent) as an electrolytic solution when MXene is used as an electrode active material of the cathode 15a, and further, a carbon-based material is used as an electrode active material of the anode 15b. In a case in which the capacitor characteristics of the electrochemical capacitor of the present embodiment are evaluated at a voltage scanning speed of 2 mV/s, the energy density can be, for example, 12 Wh/L or more, particularly 14 Wh/L or more, more particularly 16 Wh/L or more, even more particularly 20 Wh/L or more, and yet more particularly 21 Wh/L or more. The energy density can be 22 Wh/L or more and particularly about 29 Wh/L depending on the circumstances.

MXene has a larger gap between layers as compared with oxide-based materials such as MnO₂. Moreover, although the present invention is not bound by any theory, it can be understood that a sufficiently high energy density can be attained since the solvent can easily enter between the layers of MXene at the cathode 15a and the cation is easily accessible to the reaction site in between and on the surface of the layers of MXene, due to the specific mixed solution (specific combination of an electrolyte and a solvent) in the present invention. Furthermore, MXene has a higher electrical conductivity than MnO₂. Hence, MXene more easily donates and receives electrons to and from ions at the time of charge and discharge of the capacitor than MnO₂, and as a result, the capacity is larger.

The electrochemical capacitor of the present embodiment can also exhibit a sufficiently high power density. In a case in which the capacitor characteristics of the electrochemical capacitor of the present embodiment are evaluated at a voltage scanning speed of 2 mV/s, the power density can be, for example, 32 W/L or more, particularly 40 W/L or more, more particularly 43 W/L or more. The power density can be 45 W/L or more, particularly 50 W/L or more, even more particularly 55 W/L or more, and yet more particularly about 65 W/L depending on the circumstances.

Although the present embodiment is not limited, it is preferable to use MXene exhibiting a high electrical conductivity of more than 1,000 S/cm among the MXenes in order to attain a higher power density (please note that the electrical conductivity of more than 1,000 S/cm is higher than that of activated carbon (electrical conductivity of about 300 S/cm) or graphene (electrical conductivity of 500 to 1,000 S/cm) which can be used in conventional electrochemical capacitors). Examples of the MXene exhibiting a high electrical conductivity of more than 1,000 S/cm include MXene in which the formula Mₙ₊₁Xₙ is any one selected from the group consisting of Ti₃C₂, Ti₂C, and V₂C (more specifically, any one selected from the group consisting of Ti₃C₂Tₛ, Ti₂CTₛ, and V₂CTₛ). These can exhibit an electrical conductivity in a range of more than 1,000 S/cm and 10,000 S/cm or less.

In the electrochemical capacitor of the present embodiment, MXene is used as an electrode active material of the cathode. The specific capacity is less likely to decrease even when the thickness of electrode is increased to a certain extent in the case of using MXene as compared with a case of using MnO₂. Preferably, a large capacity can be secured, and thus the thickness of electrode can be further increased and can be set to, for example, 3 μm or more and particularly 5 μm or more. The upper limit thereof is not particularly limited but can be typically set to 50 μm or less.

In the electrochemical capacitor of the present embodiment, a sufficiently large specific capacity, in particular a capacity per unit mass of electrode active material, can be achieved as MXene is used as an electrode active material of the cathode and the specific mixed solution (specific combination of an electrolyte and a solvent) is used as the electrolytic solution. The capacity (F/g) per unit mass of the electrode active material (MXene) is, for example, 35 F/g or more, particularly 45 F/g or more, more particularly 60 F/g or more, preferably 100 F/g or more, more preferably 150 F/g or more, even more preferably 193 F/g or more, and yet more preferably 200 F/g or more. The upper limit thereof is not particularly limited but can be typically set to 500 F/g or less.

The capacity per unit mass of the electrode active material of the anode is not particularly limited since it changes depending on the kind of the carbon-based material contained as the electrode active material. However, the electrochemical capacitor of the present embodiment can attain a higher energy density as it has a larger specific capacity, in particular a larger capacity per unit mass of the electrode active material. The capacity per unit mass of the electrode active material (carbon-based material) is, for example, 60 F/g or more, particularly 80 F/g or more, preferably 100 F/g or more, more preferably 120 F/g or more, and even more preferably 144 F/g or more. The upper limit thereof is not particularly limited but can be typically set to 200 F/g or less.

For example, in a case in which Li-TFSI and PC are used as the electrolytic solution of the electrochemical capacitor, the cathode has the capacity of 200 F/g, the potential window of 2.6 V, and the density (MXene) of 2.5 g/cm³, and the anode has the capacity of 100 F/g, the potential window of 1.4 V, and the density (carbon-based material) of 0.5 g/cm³, the energy density can reach 37 Wh/L and can be a sufficiently high energy density. Furthermore, the energy density can reach 70 Wh/L and a significantly high value can be attained under the same conditions except that the density of the anode is 1.0 g/cm³.

Furthermore, in the electrochemical capacitor of the present embodiment, the electrolytic solution 13 contains at least one of the combinations of Li-TFSI with PC, Li—BF₄ with PC, Li-TFSI with EC and DEC, Li-TFSI with EiPS, and Na-TFSI with PC but does not contain an electrolyte which generates protons in the solvent unlike the electrochemical capacitor of Patent Literature 1. However, in the case of containing an electrolyte which generates protons, a material which is not acid-corroded by such an electrolytic solution is required to be selected as a member (a so-called package, specifically, the container (cell) 11 and the separator 17, if present) which can be in contact with the electrolytic solution in the electrochemical capacitor. In contrast, in the electrochemical capacitor of the present embodiment, it is not required to use a material exhibiting acid resistance for the member and the degree of freedom in selection of the material is excellent.

### EXAMPLES

### Example 1

An electrochemical capacitor was assembled as follows, and the energy density and the power density thereof were measured to evaluate the capacitor characteristics.

Cathode (MXene Electrode)

First, a flexible free standing film substantially composed of Ti₃C₂Tₛ was obtained in the same manner as in Example 1 of Patent Literature 1. Next, the free standing film of Ti₃C₂Tₛ thus obtained was punched into a circle having a diameter of 5 mm to obtain an MXene (Ti₃C₂Tₛ) electrode (cathode). The thickness of the MXene electrode obtained was 3.0 μm and the specific gravity thereof was 2.1 g/cm³.

Anode (CNT-Containing Reduced Graphene Oxide Electrode)

First, graphene oxide was produced by oxidizing natural graphite powder in conformity with the modified Hummers method (specifically, see Ke Li et al., “Integration of ultrathin graphene/polyaniline composite nanosheets with a robust 3D graphene framework for highly flexible all-solid-state supercapacitors with superior energy density and exceptional cycling stability,” Journal of Materials Chemistry A, 2017, vol. 5, pp. 5466-5474, particularly p. 5467). Subsequently, 1 mg of CNT (carbon nanotube) (TUBALL (trademark) manufactured by OCSiAl) and 9 mg of the graphene oxide produced were mixed together. Water was added to the mixture to obtain about 2 ml of a mixed solution of CNT, graphene oxide, and water. To the mixed solution, 70 μL of 28% aqueous ammonia solution and 20 μL of 35% hydrazine solution were added, and this mixture was stirred at 95° C. for 1 hour to obtain a mixed solution of CNT, reduced graphene oxide, ammonia, hydrazine, and water. In order to decrease the amount of ammonia and hydrazine as much as possible, the moisture in the mixed solution was removed using a vacuum aspirator. A washing operation was simultaneously performed by adding deionized water to the mixed solution little by little in a total amount of 600 ml while removing the moisture from the mixed solution by vacuum suction. The mixed solution of CNT and reduced graphene oxide thus obtained was subjected to solid-liquid separation using a vacuum aspirator and a membrane filter. A film-like material composed of CNT-containing reduced graphene oxide remaining on the membrane filter was recovered. At this time, a film was obtained by adjusting the amount of solution so that the mass per unit area of the film recovered was 1.5-fold the mass per unit area of the cathode described above. The film obtained was punched into a circle having a diameter of 5 mm to obtain a CNT-containing reduced graphene oxide electrode (anode). In other words, the respective electrodes were obtained so that the mass balance between the cathode and the anode in the cell was 1:1.5, which is a suitable ratio. The thickness of the CNT-containing reduced graphene oxide electrode obtained was 5.9 μm and the specific gravity thereof was 1.6 g/cm³.

Separator

A separator membrane was prepared by processing a commercially available separator (CELGARD 3501 (trade name) manufactured by CELGARD, LLC.) to have a diameter of 12 mm.

Electrolytic Solution

A mixed solution was prepared as the electrolytic solution by mixing Li-TFSI (product number 544094 manufactured by Sigma-Aldrich Corporation), which was an electrolyte, in PC (product number 310328 manufactured by Sigma-Aldrich Corporation), which was a solvent, at a molar concentration of 1 mol/L (based on the entire mixture).

Assembly of Electrochemical Capacitor

Swagelok tube fitting (Bored-Through Union Tee, product number SS-810-3BT, made of SUS316, manufactured by Swagelok Company) was used as the cell body. A ferrule (PTFE Ferrule Set, product number T-810-SET, made of polytetrafluoroethylene, manufactured by Swagelok Company) and an extraction electrode (12 mm in diameter, 40 mm in length, round bar made of SUS316) were used in combination in each of two facing openings. The remaining opening was sealed with a rubber plug to constitute a cell. In the glove box (both O₂ concentration and H₂O concentration were 0.1 ppm or less), the MXene electrode and the CNT-containing reduced graphene oxide electrode prepared as described above were allowed to face each other inside the cell body as a cathode and an anode, respectively, and a separator membrane was disposed to be interposed between these. The extraction electrode equipped with the ferrule was inserted and fitted from each of the two facing openings of the cell body until to come in contact with both electrodes. The electrolytic solution was filled in the cell body, and the remaining opening was sealed with a rubber plug to assemble an electrochemical capacitor for electricity storage device evaluation.

Evaluation on Capacitor Characteristics

An external electrode was connected to the electrochemical capacitor assembled above. Using an electrochemical measurement apparatus VMP3 and software EC-Lab V11.12 manufactured by Bio-Logic Science Instruments SAS, the current value (A/g) at the time of constant current charge and discharge measurement was variously set and the energy density (E=⅛·CV²) and the power density (P=E/Δt) were measured as capacitor characteristics from the specific capacity (capacity per unit mass) (F/g), potential window (V), and discharge time (Δt) on the discharge side. The specific capacity (capacity per unit mass) (F/g) and the potential window (V) were separately measured for each of the cathode (MXene electrode) and the anode (CNT-containing reduced graphene oxide electrode). The capacity per unit mass of the cathode (MXene electrode) was 193 F/g, and the potential window was 1.85 V. The capacity per unit mass of the anode (CNT-containing reduced graphene oxide electrode) was 144 (F/g), and the potential window was 1.65 (V). The results are presented in Table 1.

TABLE 1

| Current | Energy | Power | Energy | Power |
|---|---|---|---|---|
| value | density | density | density | density |
| (A/g) | (Wh/kg) | (W/kg) | (Wh/L) | (W/L) |
| 0.5 | 75 | 351 | 133 | 621 |
| 1 | 72 | 702 | 127 | 1,241 |
| 5 | 60 | 3,510 | 107 | 6,207 |
| 10 | 53 | 7,020 | 93 | 12,414 |
| 20 | 50 | 10,530 | 88 | 18,621 |
| 30 | 39 | 17,550 | 69 | 31,035 |
| 40 | 34 | 24,570 | 60 | 43,449 |
| 50 | 29 | 35,099 | 52 | 62,071 |

It can be understood based on the technologies known to those skilled in the art that a higher energy density and a higher power density are attained in the present Example 1 as compared with a case in which both the anode and the cathode are changed to the conventionally known activated carbon having an electrode density of about 0.5 g/cm³, the same electrolytic solution was used, and the measurement was performed under the same conditions of constant current charge and discharge.

### Example 2

Cathode (MXene Electrode)

A cathode (MXene electrode) produced by the same method as in Example 1 except that a free standing film of Ti₃C₂Tₛ was punched to have a diameter of 2 mm and the thickness of the MXene electrode was 5.0 μm was prepared.

Anode (CNT-Containing Reduced Graphene Oxide Electrode)

An anode (CNT-containing reduced graphene oxide electrode) produced by the same method as in Example 1 except that a film of CNT-containing reduced graphene oxide was punched into a circle having a diameter of 3.86 mm and a thickness of 6 μm and three sheets of films thus punched were stacked and applied to the capacitor was prepared. In Example 2, the mass balance between the cathode and the anode was set to be 1:2.5. Based on the previous cathode test (measurement of the capacity and the potential window of the cathode depending on the components (electrolyte and solvent) of the electrolytic solution) using the MXene electrode, the mass balance between the cathode and the anode in the present Example 2 was most preferably 1:3.5, but the mass balance of 1:2.5 was adopted in consideration of the experimental workability of the difference between thickness and diameter of the film.

Electrolytic Solution

A mixed solution obtained by mixing Li-TFSI (product number 544094 manufactured by Sigma-Aldrich Corporation), which was the same electrolyte as in Example 1, in a mixed solvent (volume ratio EC:DEC=3:7) of EC (product number 676802-1L manufactured by Sigma-Aldrich Corporation) and DEC (product number 517135 manufactured by Sigma-Aldrich Corporation) at a molar concentration of 1 mol/L (based on the entire mixture) was used as the electrolytic solution.

Assembly (including the separator) of the electrochemical capacitor was performed in the same manner as in Example 1.

Evaluation on Capacitor Characteristics

An external electrode was connected to the electrochemical capacitor assembled above. Using an electrochemical measurement apparatus VMP3 and software EC-Lab V11.12 manufactured by Bio-Logic Science Instruments SAS, the voltage scanning speed was variously set, and the energy density and the power density as capacitor characteristics were measured. The results are presented in Table 2.

TABLE 2

| Voltage scanning | Energy | Power | Energy | Power |
|---|---|---|---|---|
| speed | density | density | density | density |
| (mV/ s) | (Wh/kg) | (W/kg) | (Wh/L) | (W/L) |
| 2 | 22 | 44 | 29 | 65 |
| 5 | 17 | 85 | 22 | 126 |
| 10 | 14 | 136 | 18 | 201 |
| 20 | 11 | 212 | 14 | 314 |
| 50 | 8 | 385 | 10 | 569 |
| 100 | 6 | 588 | 8 | 871 |
| 200 | 4 | 882 | 6 | 1,306 |
| 500 | 3 | 1,474 | 4 | 2,181 |
| 1,000 | 2 | 2,140 | 3 | 3,167 |
| 2,000 | 2 | 3,090 | 2 | 4,575 |
| 5,000 | 1 | 5,048 | 1 | 7,471 |
| 10,000 | 1 | 7,383 | 1 | 10,927 |
| 20,000 | 1 | 10,870 | 1 | 16,088 |

### Comparative Example 1

An electrochemical capacitor was assembled in the same manner as in Example 2 except that an activated carbon electrode was used as both the anode and the cathode. The activated carbon electrode was produced by mixing activated carbon (YP-50 manufactured by Kuraray Co., Ltd.), carbon black (manufactured by Sigma-Aldrich Corporation) as a conductive auxiliary agent, and a 60 wt % aqueous solution of polytetrafluoroethylene (manufactured by Sigma-Aldrich Corporation) as a binder at a mass ratio of 75:15:10 and molding this activated carbon-containing mixture into a film shape using a roll. In the case of activated carbon, it is generally known that the anode and the cathode are equal to each other in potential window and capacity. For this reason, activated carbon electrode was used as the anode and the cathode in relatively close masses (that is, the mass balance between the cathode and the anode was close to 1:1). The diameter of the activated carbon electrode of the anode and the cathode was set to 5 mm, and the thickness thereof was set to 260 μm. The mass of the anode was set to 2.217 mg, the mass of the cathode was set to 2.202 mg, and the density of each electrode was 0.43 g/cm³.

By the same method as in Example 2, the voltage scanning speed was variously set and the energy density and the power density as capacitor characteristics were measured. The results are presented in Table 3. It is noted that the potential window was 2.5 V when being confirmed at the time of measurement.

TABLE 3

| Voltage scanning | Energy | Power | Energy | Power |
|---|---|---|---|---|
| speed | density | density | density | density |
| (mV/s) | (Wh/kg) | (W/kg) | (Wh/L) | (W/L) |
| 2 | 15 | 5 | 6 | 19 |
| 5 | 14 | 11 | 6 | 44 |
| 10 | 13 | 21 | 6 | 84 |
| 20 | 12 | 36 | 5 | 145 |
| 50 | 8 | 66 | 4 | 262 |
| 100 | 6 | 89 | 2 | 355 |
| 200 | 3 | 106 | 1 | 425 |
| 500 | 2 | 126 | 1 | 506 |
| 1,000 | 1 | 145 | 0 | 581 |
| 2,000 | 1 | 165 | 0 | 660 |
| 5,000 | 0 | 190 | 0 | 758 |
| 10,000 | 0 | 208 | 0 | 832 |
| 20,000 | 0 | 227 | 0 | 910 |

### Comparative Example 2

An electrochemical capacitor was assembled in the same manner as in Example 2 except that the CNT-containing reduced graphene oxide electrode produced in Example 1 was applied as both the anode and the cathode. By the previous measurement, it has been found that the potential window and the capacity when the electrode was used as the cathode are approximately the same as those when the electrode was used as the anode. For this reason, the experiment was performed so that the mass of the anode and the mass of the cathode were as equal as possible to each other, that is, the mass balance between the cathode and the anode was close to 1:1. The diameter of the CNT-containing reduced graphene oxide electrode of the anode and the cathode was set to 3.86 mm, and the thickness thereof was set to 6 μm. The mass of the anode was set to 0.070 mg, the mass of the cathode was set to 0.063 mg, and the density of each electrode was 1.32 g/cm³.

By the same method as in Example 2, the voltage scanning speed was variously set and the energy density and the power density as capacitor characteristics were measured. The results are presented in Table 4. It is noted that the potential window was 2.5 V when being confirmed at the time of measurement.

TABLE 4

| Voltage scanning | Energy | Power | Energy | Power |
|---|---|---|---|---|
| speed | density | density | density | density |
| (mV/s) | (Wh/kg) | (W/kg) | (Wh/L) | (W/L) |
| 2 | 8 | 23 | 11 | 31 |
| 5 | 6 | 47 | 9 | 62 |
| 10 | 5 | 77 | 7 | 101 |
| 20 | 4 | 123 | 6 | 162 |
| 50 | 3 | 234 | 4 | 309 |
| 100 | 3 | 364 | 3 | 480 |
| 200 | 2 | 552 | 3 | 729 |
| 500 | 1 | 943 | 2 | 1,245 |
| 1,000 | 1 | 1390 | 1 | 1,835 |
| 2,000 | 1 | 2035 | 1 | 2,686 |
| 5,000 | 0 | 3339 | 1 | 4,408 |
| 10,000 | 0 | 5070 | 0 | 6,692 |
| 20,000 | 0 | 7870 | 0 | 10,388 |

### Example 3

An electrochemical capacitor was assembled as follows, and the energy density and the power density thereof were measured to evaluate the capacitor characteristics.

Cathode (MXene Electrode)

First, a flexible free standing film substantially composed of Ti₃C₂Tₛ was obtained in the same manner as in Example 1 of Patent Literature 1. Next, the free standing film of Ti₃C₂Tₛ thus obtained was punched into a circle having a diameter of 8 mm to obtain a circular film. The thickness of this MXene circular film was 4 μm. This was pressed and attached to a stainless steel mesh (SUS 316, 500 mesh) having a diameter of 10 mm to obtain a cathode as an MXene (Ti₃C₂Tₛ) electrode. The MXene electrode had a specific gravity of 2.2 g/cm³ in the state of an MXene circular film before being pressed.

Anode (Activated Carbon Electrode)

A circular film was obtained by mixing activated carbon (YP-50 manufactured by Kuraray Co., Ltd.), acetylene black (DENKA BLACK manufactured by Denka Company Limited) as a conductive auxiliary agent, and polytetrafluoroethylene (PTFE F-104 manufactured by Daikin Industries, Ltd.) as a binder at a mass ratio of 70:20:10, molding this activated carbon-containing mixture into a film shape using a roll, and punching this film into a circle having a diameter of 8 mm. The thickness and mass of this circular film was 37 μm and 1 mg, respectively. This was pressed and attached to a stainless steel mesh (SUS 316, 500 mesh) having a diameter of 10 mm to obtain an anode as an activated carbon electrode. The activated carbon electrode had a specific gravity of 0.54 g/cm³ in the state of a circular film before being pressed. In the present Example 3, the mass balance between the cathode and the anode was set to be 1:2.1.

Separator

A separator membrane was prepared by processing a commercially available separator (ADVANTEC (registered trademark), model: GA-100, glass fiber filter manufactured by Advantec Toyo Kaisha, Ltd.) to have a diameter of 16 mm.

Electrolytic Solution

A mixed solution was prepared as the electrolytic solution by mixing Li—BF₄ (product number: LBG-44850 manufactured by Kishida Chemical Co., Ltd.) in PC (product number: 32455-08 manufactured by SASAKI CHEMICAL CO., LTD.) at a molar concentration of 1 mol/L (based on the entire mixture).

Assembly of Electrochemical Capacitor

A cell was constituted using a button battery package (product name: CR2032 Coin Cell Cases, made of SUS316, manufactured by MTI Corporation) as the cell body, one O-ring gasket, one spacer (product name: EQ-CR2325-Spacer manufactured by MTI Corporation), and two wave springs (product name: EQ-CR20WS-Spring manufactured by MTI Corporation) under these and performing sealing using a coin caulking machine (Hohsen Corp.). In a dry room (dew point: less than −60° C.) in a dry atmosphere, the MXene electrode and the activated carbon electrode prepared as described above were allowed to face to each other inside the cell body as a cathode and an anode, respectively, and a separator membrane was disposed to be interposed between these. The electrolytic solution was filled in the cell body, and the package was sealed using a coin caulking machine to assemble an electrochemical capacitor for electricity storage device evaluation.

Evaluation on Capacitor Characteristics

An external electrode was connected to the electrochemical capacitor assembled above. Using an electrochemical measurement apparatus VMP and software EC-Lab V11.20 manufactured by Bio-Logic Science Instruments SAS, the voltage scanning speed was variously set, and the energy density and the power density as capacitor characteristics were measured. The results are presented in Table 5.

TABLE 5

| Voltage scanning | Energy | Power | Energy | Power |
|---|---|---|---|---|
| speed | density | density | density | density |
| (mV/s) | (Wh/kg) | (W/kg) | (Wh/L) | (W/L) |
| 2 | 30 | 61 | 21 | 43 |
| 5 | 26 | 135 | 19 | 96 |
| 10 | 22 | 226 | 16 | 160 |
| 20 | 17 | 347 | 12 | 246 |
| 50 | 11 | 564 | 8 | 399 |
| 100 | 8 | 785 | 5 | 556 |
| 200 | 5 | 1,072 | 4 | 759 |
| 500 | 3 | 1,547 | 2 | 1,096 |
| 1,000 | 1.9 | 1,985 | 1.4 | 1,406 |
| 2,000 | 1.2 | 2,505 | 0.9 | 1,774 |
| 5,000 | 0.6 | 3,306 | 0.5 | 2,341 |
| 10,000 | 0.4 | 3,859 | 0.3 | 2,733 |
| 20,000 | 0.2 | 4,496 | 0.2 | 3,184 |

### Example 4

Cathode (MXene Electrode)

A cathode (MXene electrode) produced by the same method as in Example 3 (punching diameter: 8 mm, thickness of MXene circular film: 4 μm) was prepared.

Anode (Activated Carbon Electrode)

An anode was produced by the same method as in Example 3 (punching diameter: 8 mm) except that the thickness of the film of the activated carbon-containing mixture and thus the thickness and mass of the circular film obtained by punching this were different from those in Example 3. In the present Example 4, the mass balance between the cathode and the anode was set to be 2:3.

Electrolytic Solution

A mixed solution was prepared as the electrolytic solution by mixing Li-TFSI (product number: LBG-43511 manufactured by Kishida Chemical Co., Ltd.) in ethyl isopropyl sulfone (EiPS) at a molar concentration of 1 mol/L (based on the entire mixture).

Assembly (including the separator) of the electrochemical capacitor was performed in the same manner as in Example 3.

Evaluation on Capacitor Characteristics

The electrochemical capacitor assembled above was subjected to the characteristic evaluation in the same manner as in Example 3. The results are presented in Table 6.

TABLE 6

| Voltage scanning | Energy | Power | Energy | Power |
|---|---|---|---|---|
| speed | density | density | density | density |
| (mV/s) | (Wh/kg) | (W/kg) | (Wh/L) | (W/L) |
| 2 | 46 | 81 | 37 | 64 |
| 5 | 36 | 156 | 28 | 124 |
| 10 | 27 | 236 | 21 | 187 |
| 20 | 20 | 343 | 15 | 271 |
| 50 | 12 | 529 | 10 | 418 |
| 100 | 8 | 716 | 6 | 567 |
| 200 | 6 | 969 | 4 | 767 |
| 500 | 3.3 | 1,456 | 2.6 | 1,160 |
| 1,000 | 2.3 | 2,032 | 1.8 | 1,608 |
| 2,000 | 1.6 | 2,826 | 1.3 | 2,236 |
| 5,000 | 1.0 | 4,248 | 0.8 | 3,362 |
| 10,000 | 0.6 | 5,327 | 0.5 | 4,215 |
| 20,000 | 0.4 | 6,693 | 0.3 | 5,297 |

### Example 5

Cathode (MXene Electrode)

A cathode (MXene electrode) produced by the same method (thickness of MXene circular film: 4 μm) as in Example 3 except that a free standing film of Ti₃C₂Tₛ was punched to have a diameter of 12 mm was prepared.

Anode (Activated Carbon Electrode)

An anode was produced by the same method as in Example 3 except that the thickness and punching diameter (punching diameter: 3 mm) of the film of the activated carbon-containing mixture and thus the thickness and mass of the circular film obtained by punching this were different from those in Example 3. In the present Example 5, the mass balance between the cathode and the anode was set to be 1:1.

Electrolytic Solution

A mixed solution was prepared as the electrolytic solution by mixing Na-TFSI (product number: 50989 manufactured by Tokyo Chemical Industry Co., Ltd.) in PC (product number: 32455-08 manufactured by SASAKI CHEMICAL CO., LTD.) at a molar concentration of 1 mol/L (based on the entire mixture).

Assembly (including the separator) of the electrochemical capacitor was performed in the same manner as in Example 3.

Evaluation on Capacitor Characteristics

The electrochemical capacitor assembled above was subjected to the characteristic evaluation in the same manner as in Example 3. The results are presented in Table 7.

TABLE 7

| Voltage scanning | Energy | Power | Energy | Power |
|---|---|---|---|---|
| speed | density | density | density | density |
| (mV/s) | (Wh/kg) | (W/kg) | (Wh/L) | (W/L) |
| 2 | 39 | 75 | 34 | 65 |
| 5 | 35 | 166 | 30 | 144 |
| 10 | 29 | 275 | 25 | 239 |
| 20 | 22 | 416 | 19 | 361 |
| 50 | 14 | 670 | 12 | 581 |
| 100 | 10 | 955 | 9 | 829 |
| 200 | 7 | 1,370 | 6 | 1,189 |
| 500 | 5 | 2,161 | 4 | 1,876 |
| 1,000 | 3 | 2,955 | 2.7 | 2,564 |
| 2,000 | 2 | 3,867 | 1.8 | 3,356 |
| 5,000 | 1.1 | 5,153 | 0.9 | 4,472 |
| 10,000 | 0.7 | 6,310 | 0.6 | 5,476 |
| 20,000 | 0.4 | 7,569 | 0.3 | 6,569 |

As understood from Tables 2 to 4, electrolytic solutions (Li-TFSI with EC and DEC) composed of the same components were used in Example 2 and Comparative Example 1 and Comparative Example 2, but it was possible to attain a higher energy density and a higher power density in Example 2 than in Comparative Examples 1 and 2 at the same voltage scanning speed. In particular, as can be seen from Table 2, the energy density (Wh/L) can reach a sufficient energy density of 29 Wh/L in Example 2. There is also the possibility that a higher energy density is attained by suppressing the difference in diameter between the cathode and the anode in the mass balance, and the like, in Example 2. As can be seen from Tables 3 and 4, the energy density (Wh/L) remained at a small value of 6 Wh/L or 11 Wh/L in Comparative Examples 1 and 2.

Furthermore, according to the previous cathode test (measurement of the capacity and the potential window of the cathode depending on the components (electrolyte and solvent) of the electrolytic solution) using the MXene electrode, it has been found that suitable values of specific capacity and the potential window are attained when the MXene electrode is used as a cathode in the case of the five combinations of an electrolyte and a solvent in the following Table 8 including the combinations in Example 1 and Example 2. Moreover, it has been demonstrated from the results for Examples 1 to 5 presented in Tables 1, 2 and 5 to 7 that the electrochemical capacitors using these combinations of an electrolyte and a solvent can also attain a higher energy density and a higher power density in the same manner as in Example 2.

TABLE 8

| Electrolyte | | |
|---|---|---|
| Cation | Anion | Solvent |
| Li | TFSI | PC |
| Li | BF₄ | PC |
| Li | TFSI | EC + DEC |
| Li | TFSI | EiPS |
| Na | TFSI | PC |

Hence, according to the present invention, by use of MXene in the cathode, a transition metal atom (Ti, V or the like) in MXene stores electric charges by changing the valence of the atom itself along with the movement of electrons, an electric charge storing effect due to valence change occurs in addition to the electric double layer capacity attained by use of a carbon-based material (activated carbon, graphene or the like) in the anode, and a more sufficient capacity can be attained. As a result, such an electrochemical capacitor can achieve a sufficiently high energy density and a sufficiently high power density. Such effects can be achieved because a specific mixed solution (specific combination of an electrolyte and a solvent) is used as an electrolytic solution to be used in the electrochemical capacitor. Furthermore, according to the specific electrolytic solution described above, the electrolytic solution can have a suitable usable temperature range from a low temperature to a high temperature without generating protons in the solvent.

The electrochemical capacitor of the present invention can be widely utilized in various fields as an electricity storage device and the like but is not limited thereto.

### REFERENCE SIGNS LIST

1a, 1b, 1c Mₙ₊₁Xₙ layer
3a, 5a, 3b, 5b, 3c, 5c Modifier or terminal T
7a, 7b, 7c MXene layer
10 MXene (layered material)
11 Container (cell)
13 Non-aqueous electrolytic solution
15a Cathode
15b Anode
17 Separator
20 Electrochemical capacitor
A, B Terminal

1. An electrochemical capacitor comprising:
an electrolytic solution that is any one selected from the group consisting of a mixed solution comprising lithium bis(trifluoromethanesulfonyl)imide and propylene carbonate, a mixed solution comprising lithium borofluoride and propylene carbonate, a mixed solution comprising lithium bis(trifluoromethanesulfonyl)imide, ethylene carbonate, and diethyl carbonate, a mixed solution comprising lithium bis(trifluoromethanesulfonyl)imide and ethyl isopropyl sulfone, and a mixed solution comprising sodium bis(trifluoromethanesulfonyl)imide and propylene carbonate;
a cathode in the electrolytic solution, the cathode comprising, as an electrode active material, a layered material comprising a plurality of layers, each layer having a crystal lattice represented by:
Mₙ₊₁Xₙ
wherein M is at least one metal of Group 3, 4, 5, 6, or 7,
X is a carbon atom, a nitrogen atom, or a combination thereof,
n is 1, 2, or 3, and
each X is positioned within an octahedral array of M, and
having at least one modifier or terminal T selected from the group consisting of a hydroxyl group, a fluorine atom, an oxygen atom, and a hydrogen atom on at least one of two opposing surfaces of said each layer; and
an anode in the electrolytic solution and separated from the cathode, the anode comprising a carbon-based material as an electrode active material.

2. The electrochemical capacitor according to claim 1, wherein the Mₙ₊₁Xₙ is any one selected from the group consisting of Ti₃C₂, Ti₂C, and V₂C.

3. The electrochemical capacitor according to claim 1, further comprising a separator between the anode and the cathode.

4. The electrochemical capacitor according to claim 1, wherein a thickness of said each layer is 0.8 nm to 5 nm.

5. The electrochemical capacitor according to claim 1, wherein a thickness of said each layer is 0.8 nm to 3 nm.

6. The electrochemical capacitor according to claim 1, wherein the carbon-based material is a material having a density of 0.2 g/cm³ or more.

7. The electrochemical capacitor according to claim 1, wherein the Mₙ₊₁Xₙ has an electrical conductivity of more than 1,000 S/cm.
